(19) United States
(12) Patent Application Publication
(10) Pub. No.: US 2024/0259476 A1
(43) Pub. Date: Aug. 1, 2024

(54) METHOD, USER DEVICE, AND COMPUTER PROGRAM FOR DETERMINING PROPERTY OF SERVICE EXECUTED IN USER DEVICE BASED ON PACKET ANALYSIS

(71) Applicant: FAIRY INC., Seongnam-si (KR)

(72) Inventors: In Sun JANG, Seongnam-si (KR); Hyeon Ji LEE, Seongnam-si (KR); Jiwon SHIN, Seoul (KR)

(73) Assignee: FAIRY INC., Seongnam-si (KR)

(21) Appl. No.: 18/517,979

(22) Filed: Nov. 22, 2023

(30) Foreign Application Priority Data
Jan. 27, 2023 (KR) 10-2023-0010830
Apr. 6, 2023 (KR) 10-2023-0045541

(51) Int. Cl. H04L 67/50; H04L 67/5683; H04L 69/22

(52) U.S. Cl. CPC H04L 67/535; H04L 67/5683; H04L 69/22

(57) ABSTRACT

Disclosed are a method of determining properties of a service executed in a user terminal based on packet analysis, and a user terminal and a computer program that perform the same. The method of determining properties of a service executed in a user terminal based on packet analysis according to various embodiments of the present invention is performed by the user terminal, which includes identifying an analysis target packet among packets generated as a service is executed through the user terminal, and determining the properties of the service by analyzing the identified analysis target packet.

### CROSS-REFERENCE TO RELATED APPLICATION

This application claims priority to and the benefit of Korean Patent Application Nos. 10-2023-0010830, filed on Jan. 27, 2023, and 10-2023-0045541, filed on Apr. 6, 2023, the disclosure of which is incorporated herein by reference in its entirety.

### BACKGROUND

### 1. Field of the Invention

Various embodiments of the present invention relate to a method of determining the properties of a service executed in a user terminal based on packet analysis, and a user terminal and a computer program that perform the same.

### 2. Discussion of Related Art

This invention is filed with the support of the “2023 Global Startup Funding Program” by Gyeonggi Province and Gyeonggi-do Business & Science Accelerator (GBSA).

Recently, various online services using user terminals such as smartphones have emerged, and through these services, applications for various online services such as payment, cashback, e-commerce, advertising, marketing, management, and daily life sharing are installed and shared on the user terminals.

Applications based on mobile operating systems are designed to be suitable for various purposes and environments as the applications handle data transmission and reception with servers that provide services executed through the applications, enabling the processing of various online services and quick confirmation of the results, and are supported and serviced in various businesses.

However, with the emergence of various application services, users are faced with a lot of confusion and decision-making during actions such as using websites and making payments. For example, in the case of services such as payment, there are too many things to know, prepare, and calculate in advance, such as various simple payments, local currency, membership discounts, credit card benefits, previous month's performance, various point conditions, etc. In order to improve this inconvenience, some prior technologies propose an automated recommendation service on a service server using pre-registered personal information, as described in Korean Registration Patent No. 10-1441288.

However, the conventional technologies as described above ultimately require a separate process of collecting personal information and determining recommendations on an external server, which are vulnerable to security attacks and have problems in that both the efficiency and speed of data processing are reduced.

### SUMMARY OF THE INVENTION

The present invention is directed to providing a method of determining the properties of a specific service (e.g., the identity, event type and usage status of the service) by a user terminal within the user terminal by analyzing a packet generated as the specific service is executed through the user terminal, thereby more quickly identifying the identity, event type and usage status of the service and preventing data leakage, and a user terminal and a computer program that perform the same.

The present invention is also directed to providing a method of determining the properties of a service executed in a user terminal based on packet analysis, which is capable of determining the identity, event type and usage status of a service executed within a user terminal based on packet analysis and providing various types of guidance information (e.g., payment method recommendation guidance and product recommendation guidance {advertising}, service or function recommendation guidance, etc.) based on the determined properties, allowing users to use various services more efficiently and conveniently, and a user terminal and a computer program that perform the same.

The problems to be solved by the present invention are not limited to the problems mentioned above, and other problems that are not mentioned can be clearly understood by those skilled in the art from the description below.

According to an aspect of the present invention, there is provided a method of determining properties of a service executed in a user terminal based on packet analysis, which includes identifying an analysis target packet among packets generated as a service is executed through the user terminal; and determining properties of the service by analyzing the identified analysis target packet.

In various embodiments, the identifying of the analysis target packet may include selecting, as the service is executed through a virtual private network (VPN) module provided in the user terminal, at least one packet among the plurality of packets provided from the user terminal to a service providing server providing the service as the analysis target packet.

In various embodiments, the identifying of the analysis target packet may include deselecting, as the analysis target packet, a packet whose destination address is a private IP address or a local host address among the plurality of packets generated as the service is executed through the user terminal.

In various embodiments, the determining of the properties of the service may include extracting domain information from the identified analysis target packet, and determining the identity, event type and usage status of the service as the properties of the service using the extracted domain information.

In various embodiments, the extracting of the domain information may include acquiring uniform resource locator (URL) information from the identified analysis target packet through a local proxy module provided in the user terminal or a remote VPN server provided outside the user terminal, and extracting domain information corresponding to the service by parsing the acquired URL information.

In various embodiments, the determining of the identity, event type and usage status of the service may include determining the identity of service corresponding to the extracted domain information by matching pre-stored domain information for each service with the extracted domain information.

In various embodiments, the determining of the identity, event type and usage status of the service may include matching pre-stored domain information for each service with a plurality of pieces of domain information extracted from the plurality of packets generated as the service is executed through the user terminal and storing a result of the matching, and determining the usage status of the service by analyzing the plurality of pieces of domain information, which are matched with the pre-stored domain information for each service and stored, based on a preset usage status determination criterion, the preset determination criterion being based on the identity, event type of service and a current usage status of the service.

In various embodiments, the extracted domain information may include domain name information, information on the number of domain calls, domain call time information, domain call frequency information, domain type information, and access platform information(such as web, mobile apps, OS), and the determining of the identity, event type and usage status of the service may include selecting at least one piece of information among a plurality of pieces of information included in the extracted domain information, the plurality of pieces of information including domain name information, information on the number of domain calls, domain call time information, domain call frequency information, domain type information, and access platform information, based on the identity, event type of service and the usage state that will be determined, and determining the usage status of the service to be one of a service execution state, a service usage state, and a state in which a specific operation is performed in the service, using the selected at least one piece of information.

In various embodiments, the determining of the identity, event type and usage status of the service may include setting a usage status determination criterion for the service in consideration of at least one of an operating system (OS) of the user terminal and an access method of the service, and determining the usage status of the service by analyzing the extracted domain information according to the set usage status determination criterion.

In various embodiments, the determining of the identity, event type and usage status of the service may include extracting a domain information pattern as result data obtained by analyzing the extracted domain information through an artificial intelligence (AI) model previously trained according to a machine learning-based learning method, and determining the usage status of the service based on the extracted domain information pattern.

According to another aspect of the present invention, there is provided a user terminal that performs a method of determining properties of a service executed in a user terminal based on packet analysis, which includes a VPN module configured to identify an analysis target packet among packets generated as a service is executed, a local proxy module configured to extract domain information from the identified analysis target packet, and a service property determination module configured to determine the properties of the service by analyzing the identified analysis target packet.

According to still another aspect of the present invention, there is provided a computer program that is connected to a user terminal and stored in a recording medium readable by a computing device in order to execute a method of determining properties of a service executed in a user terminal based on packet analysis, which includes identifying an analysis target packet among packets generated as a service is executed through the user terminal, and determining properties of the service by analyzing the identified analysis target packet.

Other specific details of the present invention are included in the detailed description and drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a system of determining the properties of a service executed in a user terminal based on packet analysis according to an embodiment of the present invention;

FIG. 2 is a diagram illustrating a hardware configuration of a user terminal that performs a method of determining the properties of a service executed in a user terminal based on packet analysis according to another embodiment of the present invention;

FIG. 3 is a flowchart illustrating a method of determining the properties of a service executed in a user terminal based on packet analysis according to still another embodiment of the present invention;

FIG. 4 is a diagram illustrating a process of determining the properties of a user using a local proxy module in various embodiments;

FIG. 5 is a diagram illustrating a process of determining the properties of a service using a remote virtual private network (VPN) server in various embodiments; and

FIG. 6 is a diagram illustrating a process of determining the usage status of a service through domain information matching in various embodiments.

### DETAILED DESCRIPTION OF EXEMPLARY EMBODIMENTS

The advantages and features of the present invention and methods for achieving the same will become apparent with reference to the embodiments described below in detail in conjunction with the accompanying drawings. However, the present invention is not limited to the embodiments disclosed below, and may be implemented in various different forms. The present embodiments are provided only to ensure the disclosure of the present specification is complete and to completely inform those of ordinary skill in the art of this specification the scope of the present invention, and the specification will be defined by the scope of the claims.

The terminology used herein is for the purpose of describing particular embodiments only and is not intended to limit the invention. In this specification, the singular also includes the plural unless specifically stated otherwise in the context. As used herein, “comprises” and/or “comprising” does not exclude the presence or addition of one or more other components in addition to the mentioned components. Like reference numerals refer to like elements throughout the specification and “and/or” includes each of the components mentioned and includes all combinations thereof. Although the terms “first,” “second,” and the like are used to describe various components, it goes without saying that these components are not limited by these terms. These terms are used only to distinguish one component from other components. Therefore, it goes without saying that the first component mentioned below may be the second component within the technical scope of the present invention.

Unless otherwise defined, all terms (including technical and scientific terms) used in the present specification may be used in a sense that can be commonly understood by those skilled in the art to which the present invention pertains. In addition, terms defined in the commonly used dictionary are not ideally or excessively interpreted unless clearly specifically defined.

The term “unit” or “module” used herein refer to a software component, or a hardware component such as a field programmable gate array (FPGA) or application-specific integrated circuit (ASIC), and performs a certain function. However, the “unit” or “module are not limited to software or hardware. The “unit” or “module” may be configured to reside on an addressable storage medium and may be executed by one or more processors. Hence, the “unit” or “module” includes elements such as software elements, object-oriented software elements, class elements, and task elements, and processes, functions, attributes, procedures, subroutines, segments of program code, drivers, firmware, micro-code, circuits, data, databases, data structures, tables, arrays, and variables. The functions provided in the elements, the units, and the modules may be combined into a fewer number of elements, units, and modules, or may be divided into a larger number of elements, units, and modules.

Spatially relative terms “below,” “beneath,” “lower,” “above,” “upper,” and the like may be used to easily describe the correlation between one component and other components as illustrated in the drawings. The spatially relative terms should be understood as including different directions of components during use or operation in addition to the directions shown in the drawings. For example, when components shown in the drawings are inverted, a first component described as “below” or “beneath” a second component may be disposed “above” the second component. Therefore, the illustrative term “below” can include both downward and upward directions. The components can also be oriented in different directions, and therefore the spatially relative terms can be interpreted according to the orientation.

In this specification, a computer means all kinds of hardware devices including at least one processor, and can be understood as including a software configuration which operates on the corresponding hardware device, according to the embodiment. For example, the computer may be understood as a meaning including all of smart phones, tablet PCs, desktops, laptops, and user clients and applications running on each device, but is not limited thereto.

Hereinafter, embodiments of the present invention will be described with reference to the accompanying drawings.

Each step described in this specification is described as being performed by a computer, but the subject of each step is not limited thereto. That is, according to the embodiments, some of the steps may be performed by a different device as well.

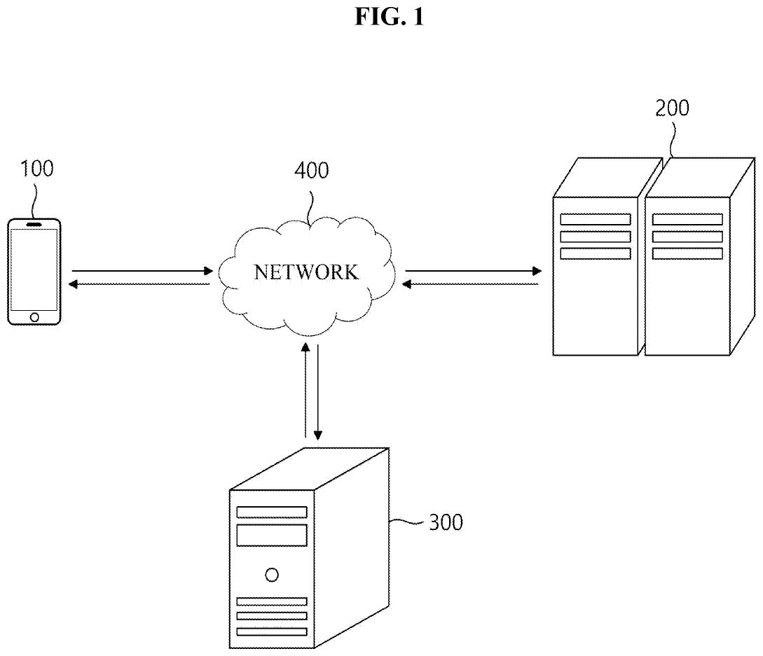

FIG. 1 is a diagram illustrating a system of determining the properties of a service executed in a user terminal based on packet analysis according to an embodiment of the present invention.

Referring to FIG. 1, a system of determining the properties of a service executed in a user terminal based on packet analysis according to an embodiment of the present invention may include a user terminal 100, a service providing server 200, an external server 300, and a network 400.

Here, the system of determining the properties of the service executed in the user terminal based on packet analysis shown in FIG. 1 is implemented according to one embodiment, and components of the system are not limited to the embodiment shown in FIG. 1 and may be added, changed, or removed as needed.

In an embodiment, the user terminal 100 may perform the method of determining the properties of a service executed in a user terminal based on packet analysis. Here, the method of determining the properties of a service executed in a user terminal based on packet analysis may be a method of determining the identity, event type and usage status of the service, as the properties of the service executed through the user terminal for the purpose of providing various types of information according to an application and/or website that the user is using through the user terminal 100. For example, the user terminal 100 may identify an analysis target packet among packets generated as the service is executed through the user terminal 100, and determine the properties of the service by analyzing the identified analysis target packet.

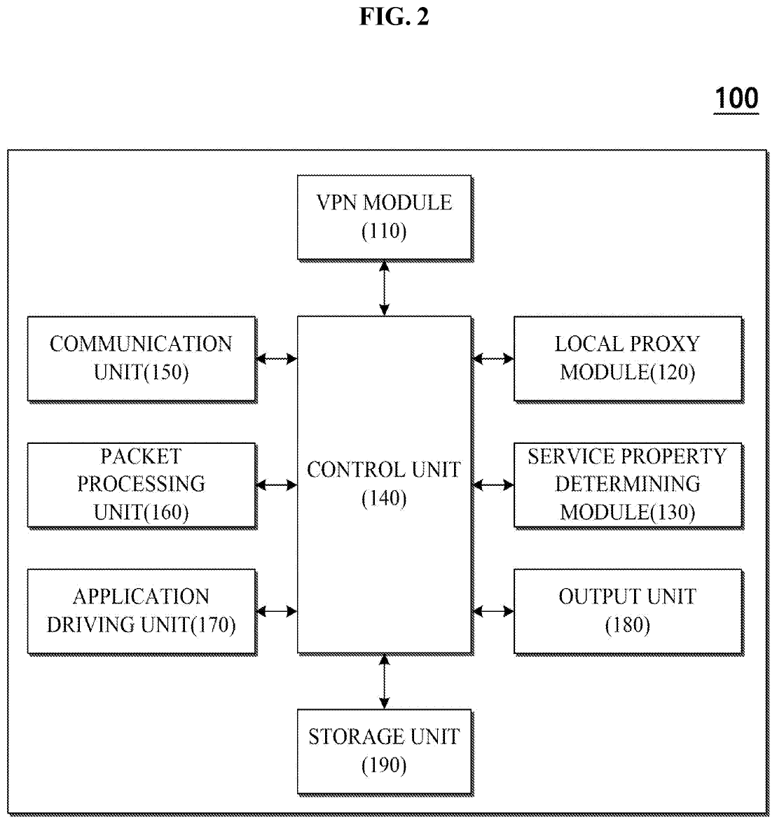

Here, the user terminal 100 may refer to arbitrary type(s) of entity (entities) in a system that has a mechanism for communicating with a computing device or server. For example, such a user terminal 100 may include a personal computer (PC), a notebook, a mobile terminal, a smartphone, a tablet PC, a wearable device. etc., and include any type of terminal that can access wired/wireless networks. In addition, the user terminal 100 may include an arbitrary computing device implemented by at least one of an agent, an application programming interface (API), and a plug-in. In addition, the user terminal 100 may include an application source and/or a client application. Hereinafter, with reference to FIG. 2, the hardware configuration of the user terminal 100 that performs the method of determining the properties of a service executed in a user terminal based on packet analysis will be described.

FIG. 2 is a diagram illustrating a hardware configuration of a user terminal that performs a method of determining the properties of a service executed in a user terminal based on packet analysis according to another embodiment of the present invention.

Referring to FIG. 2, in various embodiments, the user terminal 100 may perform the method of determining the properties of a service executed in a user terminal based on packet analysis. To this end, the user terminal 100 may include a virtual private network (VPN) module 110, a local proxy module 120, a service property determining module 130, a control unit 140, a communication unit 150, a packet processing unit 160, an application driving unit 170, an output unit 180, and a storage unit 190, but is not limited thereto.

First, the VPN module 110 may identify an analysis target packet among packets generated as the service is executed through the user terminal 100. For example, when an application that provides a specific service is executed through the user terminal 100 or a website that provides a specific service is accessed, a plurality of packets to be transmitted from the user terminal 100 to the service providing server 200 for providing a specific service may be generated, and the VPN module 110 may identify at least one packet for determining the properties of the specific service among the plurality of packets as the analysis target packet.

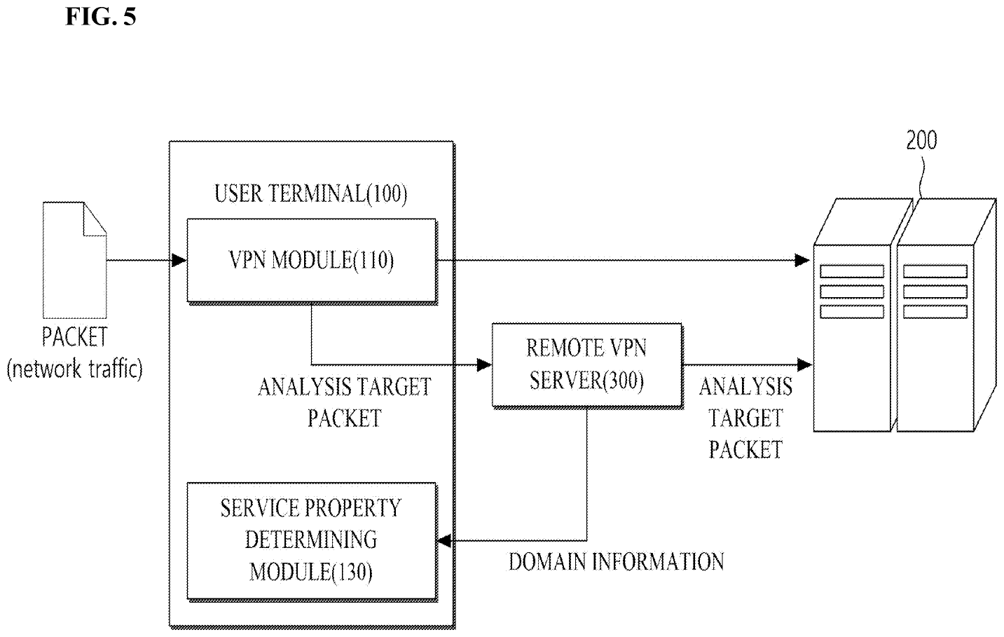

Here, when at least one packet among the plurality of packets is identified as an analysis target packet, the VPN module 110 may allow the local proxy module 120 to perform a domain information extraction operation on the analysis target packet by transmitting the identified analysis target packet to the local proxy module 120, which will be described below. However, the present invention is not limited thereto, and when the local proxy module 120 is not provided within the user terminal 100 as shown in FIG. 5, by transmitting the analysis target packet to the remote VPN server 300 provided separately outside the user terminal 100, the domain information extraction operation may be performed on the analysis target packet through the remote VPN server 300.

Meanwhile, when all packets generated through the user terminal 100 are analyzed, there is a problem of inefficiency because packets that are not related to the service are also analyzed. In consideration of this, the VPN module 110 may transmit the remaining packets that are not analysis target packets, that is, packets that are not required to be identified, to the service providing server 200 corresponding to the destination address of the packets while transmitting the analysis target packet among the plurality of packets to the local proxy module 120 (or an external remote VPN module 300), and thus it is possible to more efficiently determine the properties of the service and at the same time ensure that the services provided from the service providing server 200 are driven smoothly.

In various embodiments, the VPN module 110 may perform packet conversion and encryption processing for communication with the service providing server 200 that provides a specific service. To this end, the VPN module 110 may include a network communication module, but is not limited thereto.

Next, the local proxy module 120 may receive the analysis target packet from the VPN module 110, and extract domain information by analyzing the analysis target packet. For example, the analysis target packet may include an http version, a type of http method (e.g., POST, GET, etc.), and uniform resource locator (URL) information, and the local proxy module 120 may acquire URL information from the analysis target packet and extract domain information corresponding to the service by parsing the URL information.

Here, the domain information extracted from the local proxy module 120 may include domain name information, information on the number of domain calls, domain call time information, domain call frequency information, domain type information, and access platform information, but is not limited thereto.

Here, the local proxy module 120 may be written using SwiftNIO and implemented in a form that can process http requests, but is not limited thereto.

In addition, the local proxy module 120 may be established using a packet tunnel provider function, which is one of the network extensions provided by the iOS operating system.

The local proxy module 120 may transmit received packets to the service providing server 200 using the packet tunnel provider function, and at the same time parse domain information and transmit the parsed information to the service property determining module 130. Through this, domain information analysis of the packets transmitted from the user terminal 100 may be performed without incurring additional costs.

More specifically, the packet tunnel provider service function is basically a tool for generating a VPN application, and may configure a separate local proxy server to transmit all packet traffic generated from the user terminal 100 to the configured local proxy server, so that the packet tunnel provider service function can be used to recognize the usage status of the service accessed by the user terminal 100. Accordingly, depending on the operating system such as iOS, implementation of the operating system can be easily handled.

However, considering that packet data is binary data, the local proxy module 120 may be implemented as a local proxy server using known open source libraries, etc., and may include packet parsing logic. Through this, the local proxy module 120 may extract domain information from binary packet data.

Next, the service property determining module 130 may receive domain information from the local proxy module 120 and determine the properties of the service by analyzing the domain information. For example, the service property determining module 130 may determine the identity, event type and usage status of the service executed in the user terminal 100 based on at least one piece of information of domain name information, information on the number of domain calls, domain call time information, domain call frequency information, domain type information, and access platform information.

Here, the usage status of the service may refer to an action performed by the user or the user's intention with respect to a specific service. For example, the usage status of the service may include execution of the service (e.g., executing a service for the first time, or executing a service that was only operating in the background in the foreground), usage of the service, and performing a specific action in the service.

Here, the user may be the owner of the user terminal 100, but is not limited thereto, and may be all users or a specific user selected based on past records (e.g., a user with a history of using a specific service for a predetermined period of time, etc.).

In addition, the action performed by the user may be an action performed directly by the user within a service domain, such as access payment, but is not limited thereto.

In addition, the user's intention may refer to an action that is predicted to be performed by the user based on the sum of several signals (e.g., visiting travel sites such as “hotels.com,” “expedia.com,” etc., more than a predetermined number of times within one hour, etc.) such as “surfing for a trip” or “comparing to purchase.”

Next, the control unit 140 may control the operations of components provided in the user terminal 100. For example, the control unit 140 may control the operation of the VPN module 110 to identify an analysis target packet, control the operation of the local proxy module 120 to extract domain information, and control the operation of the service property determining module 130 to determine the properties of the service.

In various embodiments, the control unit 140 may provide guidance information based on the properties of the service executed through the user terminal 100. For example, the control unit 140 may generate a notification message containing guidance information based on the identity, event type and usage status of the service executed through the user terminal 100, and may control the generated notification message to be output through the output unit 180.

This processing operation of the control unit 140 may be processed according to the background driving of the user terminal 100, and interface driving information may be processed in a notification message output manner according to the foreground driving. Furthermore, the interface driving information may be output through the output unit 180 in the form of a notification message of voice or text information.

Here, the foreground method is a service method in which an application is executed on the memory of the storage unit 190 under the control of the control unit 140, and may be a method in which the driving of an application being executed is output through a screen interface on a display of the output unit 180. When foreground execution is terminated, an application service may be terminated and may also be terminated on the screen. On the other hand, the background method may be a method in which even an application being executed can be executed and terminated without being displayed on the screen, and may be driven without the user being aware of the application. Here, the storage unit 190 may store and manage data necessary to provide services according to an embodiment of the present invention.

Next, the communication unit 150 may perform communication with an external device. For this purpose, the communication unit 150 may include one or more communication modules. Here, the communication unit 150 may include a communication module that is connected in a wireless or wired manner through a local area network (LAN) and an Internet network, a communication module that is connected through a universal serial bus (USB) port, a communication module that is connected through a mobile communication network such as 3G or 4G, and a communication module that is connected through short-range wireless communication methods such as near field communication (NFC), radio frequency identification (RFID), Wi-Fi, etc., but is not limited thereto.

Next, the packet processing unit 160 may perform packet conversion and transmission/reception processing of packet data transmitted/received to/from the service providing server 200 through the VPN module 110, according to the application driving of the application driving unit 170. The packet data processed by the packet processing unit 160 may be transmitted and received to and from the service providing server 200 through the communication unit 150 via the VPN module 110, but is not limited thereto.

In addition, a packet corresponding to a predetermined condition may be identified as an analysis target packet in the VPN module 110 and transmitted to the local proxy module 120, and the local proxy module 120 may transmit the identified packet to the service providing server 200 and the service property determining module 130.

Here, the predetermined condition may include address information, time information, etc. For example, among a plurality of packets generated as the corresponding service is executed through the user terminal 100, a packet whose destination address is a private IP address or a local host address may be deselected as the analysis target packet.

Next, the application driving unit 170 may drive an application according to a user input.

Here, the application may include a web application, a delivery application, a shopping application, a commerce application, a cashback application, a payment application, an advertising application, a marketing application, a parental control application, a corporate management application, and a daily life sharing application, but is not limited thereto.

In addition, the service executed through the user terminal 100 has been described as a service executed by driving an application installed in the user terminal 100, but is not limited thereto. Here, the service may further include services that are executed in various ways such as a service executed by accessing a web site, etc.

In addition, the application driving unit 170 may collect, store, and manage the user's application processing data. For example, the application driving unit 170 may store and manage user location information, Wi-Fi access information, web access information, application execution information, payment record information, VPN access information, etc., and at least some of the stored information may be transmitted to the service property determining module 130.

Referring again to FIG. 1, in various embodiments, the user terminal 100 may perform user interface driving control in such a way that notification information is output in real time according to various network operating environments of services (e.g., shopping, lodging, web, commerce, advertising, marketing, parental control, corporate management, daily life sharing, etc.) determined to be used by the user.

For example, when it is determined that the user terminal 100 has accessed an e-commerce site (e.g., Coupang site) through the user terminal 100, the user terminal 100 may identify an analysis target packet among packets transmitted and received from and to an e-commerce server as the user uses the e-commerce site, determine at least one of whether a cashback service is executed within the e-commerce site, whether the cashback service is used, and whether a cashback service action is processed, as the usage status of the e-commerce site by analyzing domain information extracted from the analysis target packet, and output (e.g., pop-up) a notification message including cashback-related guidance information according to the determination result.

For example, when an action for wanting to acquire cashback is recognized as the usage status of the service executed in the user terminal 100 by analyzing the domain information extracted from the analysis target packet, the user terminal 100 may output a notification information (e.g., notification information containing the content such as “If you access this link, you can receive 3% cashback.”) containing guidance information that guides the user to receive cashback. Within this notification message, cashback-related link information may be inserted in the form of parameters of an affiliate code. In the related art, such affiliate code insertion is performed by operating a web browser function through external server confirmation, but in the embodiment of the present invention, the user's service usage status may be determined only through the own process of the user terminal 100, and the related service information may be provided quickly and safely.

For another example, when the user's intention to purchase a specific product is recognized as the usage status of the service executed in the user terminal 100 by analyzing the domain information extracted from the analysis target packet, the user terminal 100 may output a notification message containing information that induces the user to actually purchase the product (e.g., a notification message containing content such as “We are having an event”).

For another example, when the intention to pay for a specific product is recognized as the usage status of the service executed in the user terminal 100 by analyzing the domain information extracted from the analysis target packet, the user terminal 100 may output a notification message (e.g., a notification message containing content such as “Interest-free installments if you pay with Samsung Card”) containing information that recommends and guides a payment method.

In particular, when the usage status of the service is before payment, this notification message can be provided as a significantly important signal to a company that has the payment method (e.g., credit card company or the like).

In various embodiments, when an advertising service or analytics service is executed through the user terminal 100, the user terminal 100 may determine at least one of whether an advertising-related specific service is executed, whether the specific service is used, or whether a specific service action is processed, and transmit advertising analysis information according to the determination result to an analysis server (not shown).

In addition, when a targeted marketing service is executed based on real-time business visits through the user terminal 100, the user terminal 100 may determine at least one of whether a specific service associated with business visit information is executed, whether the specific service is used, and whether a specific service action is processed, and transmit analysis information according to the determination result to the analysis server (not shown). For example, when users of “Today's Home” enter Instagram, notifications such as “View products at Today's Home” may be provided.

In addition, when a service with a parental control function or corporate management function is executed through the user terminal 100, the user terminal 100 may determine at least one of whether a specific service is executed, whether the specific service is used, and whether a specific service action is processed in order to block harmful websites that children or employees enter or to track which sites the children or employees entered.

In addition, the user terminal 100 may track and share a website or application that a specific user enters like a diary, based on the determination of the user's service usage status.

In an embodiment, the service providing server 200 may be a server that provides a service that is executed by driving an application through the user terminal 100 or accessing a website. Here, the service may include a service that provides various types of information such as shopping, delivery, lodging, advertising, marketing, parental control, corporate management, daily life sharing, etc.

In various embodiments, the service providing server 200 may be constituted of one or more server devices that are connected to the user terminal 100 through the network 400, receives and processes a data packet generated as the service is executed through the user terminal 100, and transmits the processing result of the data packet to the user terminal 100.

Here, the network 400 may refer to a connection structure that allows information exchange between nodes, such as a plurality of terminals and servers. For example, the network 400 may include a local area network (LAN), a wide area network (WAN), the World Wide Web (WWW), a wired and wireless data communication network, a telephone network, and a wired and wireless television communication network.

The wireless data communication network may include 3G, 4G and 5G networks, a 3rd generation partnership project (3GPP) network, a 5th generation partnership project (5GPP) network, a long term evolution (LTE) network, a world interoperability for microwave access (WiMAX) network, Wi-Fi, the Internet, a local area network (LAN), a wireless local area network (wireless LAN), wide area network (WAN), a personal area network (PAN), a radio frequency (RF) network, a Bluetooth network, an NFC network, a satellite broadcasting network, an analog broadcasting network, a digital multimedia broadcasting (DMB) network, etc., but is not limited thereto.

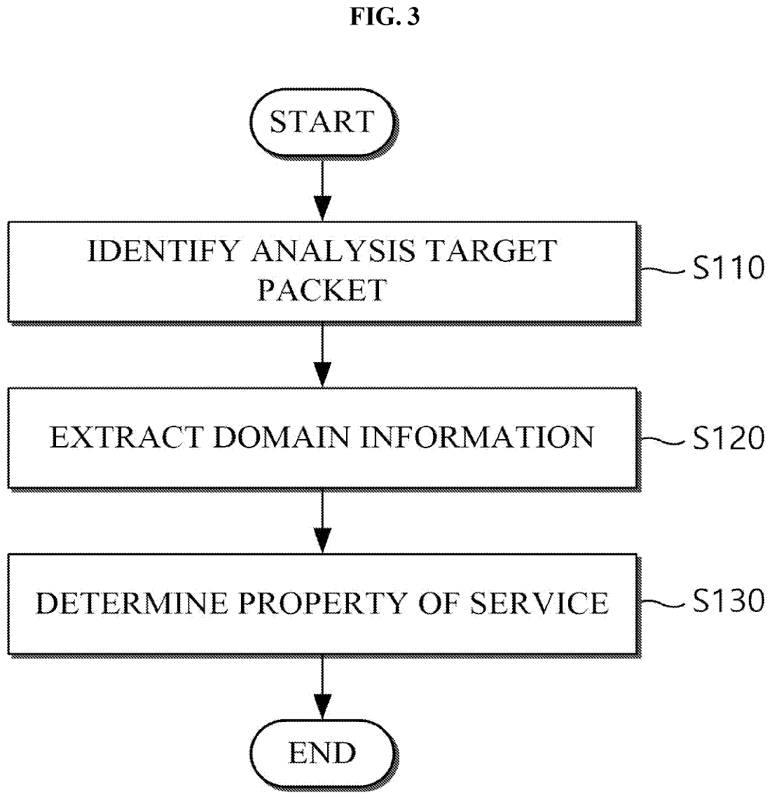

In an embodiment, the external server 300 may be connected to the user terminal 100 through the network 400, and the user terminal 100 may provide various types of information and data needed to perform the method of determining the properties of a service executed in a user terminal based on packet analysis. For example, the external server 300 may be a remote VPN server that is provided outside the user terminal 100, receives the analysis target packet from the user terminal 100, and provides domain information extracted from the analysis target packet to the user terminal 100, but is not limited thereto. Hereinafter, with reference to FIGS. 3 to 6, the method of determining the properties of a service executed in a user terminal 100 based on packet analysis, which is performed through the user terminal 100, will be described.

FIG. 3 is a flowchart illustrating a method of determining the properties of a service executed in a user terminal based on packet analysis according to still another embodiment of the present invention.

Referring to FIG. 3, in operation S110, an analysis target packet is identified among packets generated as a service is executed through the user terminal 100. For example, at least one packet among a plurality of packets may be selected as the analysis target packet through the VPN module 110 provided in the user terminal 100.

Here, the plurality of packets may be packets provided from the user terminal 100 to the service providing server 200 that provides a specific service as the specific service is executed through the user terminal 100, but is not limited thereto.

In various embodiments, when it is desired to determine the properties of a specific service while the analysis target packet is selected through the VPN module 110, the user terminal 100 may select only packets related to the specific service among the plurality of packets as the analysis target packet.

In various embodiments, the user terminal 100 may identify an analysis target packet through the VPN module 110, but deselect a packet whose destination address is a private IP address or a local host address as the analysis target packet.

In various embodiments, the user terminal 100 may transmit packets identified as the analysis target packet to the local proxy module 120 (or the remote VPN server 300) through the VPN module 110.

In this case, the user terminal 100 may transmit packets that are not identified as the analysis target packet, that is, packets that are not required to be identified, to the original destination address of the packets through the VPN module 110, thereby ensuring that the services provided from the service providing server 200 can be smoothly driven.

In operation S120, domain information is extracted from the analysis target packet identified through operation S110. For example, since the analysis target packet includes an http version, an http method type (e.g., POST, GET, etc.), and URL information, the user terminal 100 may acquire URL information from the analysis target packet, and parse the URL information to extract domain information corresponding to the service.

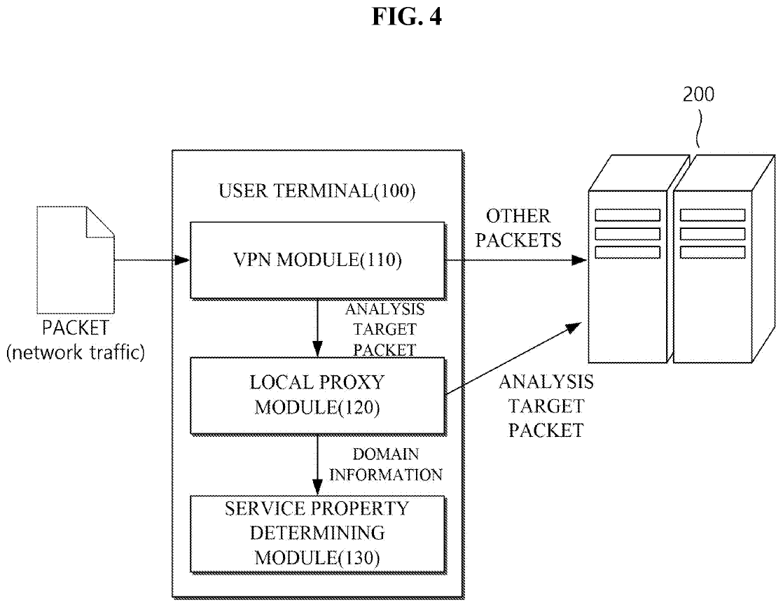

Here, as shown in FIG. 4, the user terminal 100 may transmit the analysis target packet identified through the VPN module 110 to the local proxy module 120 provided in the user terminal 100 to extract the domain information from the analysis target packet through the local proxy module 120, but is not limited thereto. As shown in FIG. 5, the analysis target packet identified through the VPN module 110 may be transmitted to the remote VPN server 300 separately provided outside the user terminal 100, thereby extracting the domain information from the analysis target packet through the remote VPN server 300.

Meanwhile, since URL information called when each service is used is needed to determine the usage status of the service using the domain information extracted from the packets, each service has characteristics in which the URL called and its frequency vary depending on the type of operating system (e.g. Android, iOS) on which each service runs, a connection method (e.g. own application, web browser, etc.), and the current usage status of each service.

Accordingly, the user terminal 100 may individually extract and collect domain information for each service in order to more accurately determine the usage status of each of the different services.

In addition, in order to accurately classify the usage status for each service, the user terminal 100 may pre-build a mapping table in which the domain information and the service usage status information are mapped for each service, and continuously perform optimization on the pre-built mapping table.

In operation S130, the properties of the service executed in the user terminal 100 are determined based on the domain information extracted through operation S120. For example, the user terminal 100 may determine the identity, event type of service and the usage status of the service by analyzing the domain information through the service property determining module 130.

In various embodiments, the user terminal 100 may determine the properties of the service executed through the user terminal 100 based on a matching algorithm. For example, the user terminal 100 may determine the identity, event type of service corresponding to the domain information by matching the domain information extracted from the analysis target packet with pre-stored domain information for each service through the service property determining module 130.

Here, the pre-stored domain information for each service refers to data that previously lists domain information corresponding to the service type or data obtained by previously listing the domain information corresponding to the identity, event type of service or information on the identity, event type of service that can be provided for each domain. Here, the pre-stored domain information may specify the identity, event type of service corresponding to the domain information, that is, the identity, event type of service being executed through the user terminal 100, by matching the pre-stored domain information for each service with the domain information extracted from the analysis target packet as described above.

As another example, the user terminal 100 may determine the usage status of the service based on the result of matching a plurality of pieces of domain information extracted from a plurality of packets with the pre-stored domain information for each service.

More specifically, first, the user terminal 100 may match a plurality of pieces of domain information extracted from a plurality of packets generated as the service is executed through the user terminal 100 and the pre-stored domain information for each service, and store the result of the matching.

In various embodiments, the user terminal 100 may match a predetermined number of pieces of domain information (e.g., up to N pieces of domain information) with the pre-stored domain information for each service based on the last extracted domain information among the plurality of pieces of domain information extracted from the plurality of packets generated as the service is executed through the user terminal 100, and store the result of the matching. Alternatively, the user terminal 100 may match a plurality of pieces of domain information extracted within a predetermined time (e.g., domain information extracted during the most recent M hours) with the pre-stored domain information for each service, and store the result of the matching.

That is, the plurality of pieces of domain information provided through the local proxy module 120 may be stored and managed based on the maximum number and expiration time. For example, when the expiration time of the pre-stored domain information has been exceeded or the number of pieces of pre-stored domain information has exceeded a predetermined number, at least some of the pre-stored domain information (e.g., domain information whose expiration time has passed or domain information with the oldest stored period) may be deleted to reduce unnecessary memory usage.

In addition, since the plurality of pieces of domain information provided through the local proxy module 120 do not include information on the service corresponding to each piece of domain information, each piece of domain information and the pre-stored domain information for each service may be collected and stored.

In various embodiments, the user terminal 100 may match only domain information of services whose usage status is to be determined among the plurality of pieces of domain information extracted from each of the plurality of packets with the pre-stored domain information for each service, and store the result of the matching.

In various embodiments, the user terminal 100 may recognize and filter the patterns of domain information unrelated to the usage of the service among the plurality of pieces of domain information extracted from each of the plurality of packets.Here, the patterns of the domain information unrelated to the usage of the service may be a common characteristic or a predefined pattern extracted through big data analysis of the plurality of pieces of domain information unrelated to the usage of the service, but the present invention is not limited thereto.

Next, the usage status of the service may be determined by analyzing the plurality of pieces of domain information that are matched with the pre-stored domain information for each service and stored.

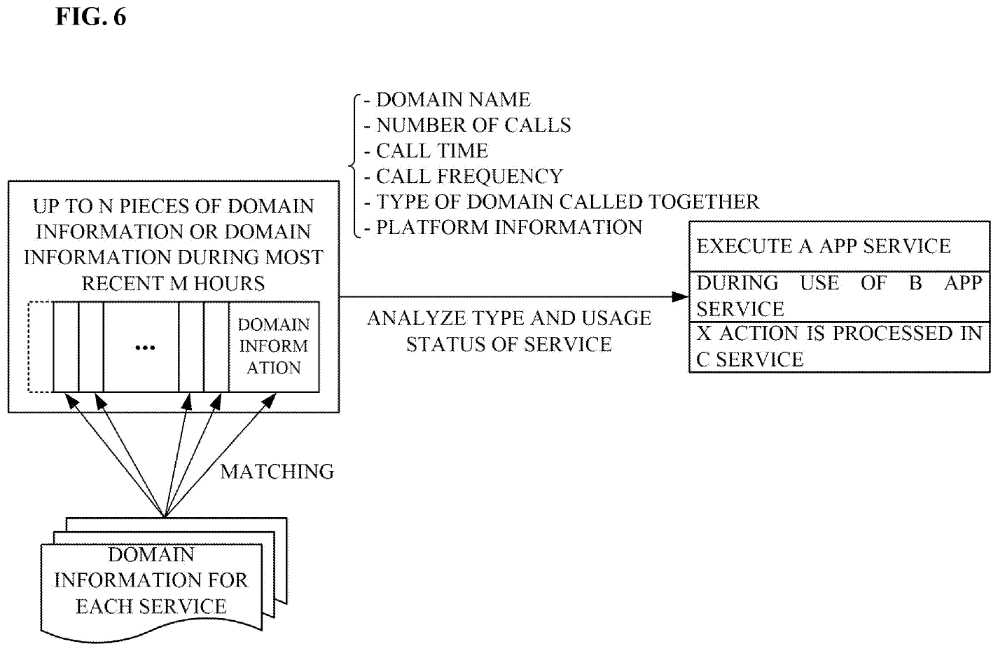

Here, referring again to FIG. 6, the domain information used to determine the usage status of the service may include the domain, call time, number of calls, call frequency, type of domain called together, and platform information, and the user terminal 100 may selectively use information required according to the service among such information through the service property determining module 130. Since there are many cases where it is difficult to determine the status of the service with just one piece of information, in most cases, various pieces of information must be gathered together. For example, when the status of the service is determined only by the domain, calling the domain is also possible from a background task, so that the domain can be called even when the user is not actually using the service. Therefore, since the used information varies depending on the usage status and platform of each service, optimization may be necessary for each service desired to be recognized and the usage status of the service.

For example, the most basic way to determine the usage status of the service is to use the domain and call frequency. For example, when domain X is called more than Z times within Y seconds, it may be determined that a certain service is being executed for the first time.

In addition, in cases where it is difficult to recognize the service based on only the domain and call frequency, other information may be needed. For example, in order to recognize a specific action in any service, the specific action may be recognized only when calling domain A and then calling domain B.

In addition, depending on the identity, event type of service, each service may be recognized using only one domain or may be recognized by using multiple domains. Therefore, the type and number of domains required to recognize the service may vary depending on the service. In addition, since there are cases where multiple services call the same domain, in those cases, it is necessary to use another method to distinguish the services. For example, assuming that service A calls domain X and service B calls X and Y, service B should be recognized only when domain X is called together with Y, and service A should be recognized when only X is called.

In consideration of the above-mentioned content, the user terminal 100 may predefine data on the properties of information (e.g., information type, number of pieces of information, etc.) required for each usage status of the service desired to be determined through the identity, event type of service and domain analysis. Next, the user terminal 100 may select at least one piece of information, that is, information needed to determine the usage state, among the plurality of pieces of information included in the domain information based on the identity, event type of service, the usage status to be determined, and the predefined data, and determine the usage status of the service to be one of a service execution state, a service usage state, and a state in which a specific operation is performed in the service by analyzing the selected information.

In addition, even for the same service, the standards may vary depending on the OS or access method. For example, when there are three ways to use service X, that is, accessing a web page through an Android application, iOS application, and Chrome, each different domain can be called and the call frequency can also vary. Therefore, in order to recognize the service in all cases, different optimizations may be required depending on each platform.

Taking this into account, the user terminal 100 may set a usage status determination criterion for the service in consideration of at least one of the operating system (OS) of the user terminal 100 and the service access method, and determine the usage status of the service by analyzing the domain information according to the usage status determination criterion.

In various embodiments, since the criteria for determining the usage status of the service are different depending on the identity, event type of service and the current usage status of the service, the user terminal 100 may determine the usage status criterion for the service based on the identity, event type of service and the current usage status of the service, and determine the usage status of the service by analyzing the plurality of pieces of domain information which are matched with the pre-stored domain information for each service according to the usage status determination criterion and stored.

In various embodiments, the user terminal 100 may analyze the domain information through a pre-trained artificial intelligence model according to a machine learning-based learning method (e.g., various known machine learning algorithms such as CNN, RNN, DNN, LSTM, etc.) to extract a domain information pattern as the analysis result data, and determine the usage status of the service based on the domain information pattern.

Here, the domain information pattern may refer to common characteristics extracted by comparing domain information extracted from the analysis target packet collected within a predetermined first number of packets during a predetermined first time.

The above-described method of determining the properties of a service executed in a user terminal based on packet analysis was explained with reference to the flowchart shown in the drawing. For simple explanation, the method of determining the properties of a service executed in a user terminal based on packet analysis is illustrated and described as a series of blocks. However, the present invention is not limited to the order of the blocks, and some blocks may be performed simultaneously or in a different order from that shown and described herein. In addition, new blocks not described in this specification and drawings may be added, or some blocks may be deleted or changed.

As described above, according to various embodiments of the present invention, it is possible to determine the properties of a specific service (e.g., the identity, event type and usage status of the service) by a user terminal within the user terminal by analyzing a packet generated as the specific service is executed through the user terminal, thereby more quickly identifying the identity, event type and usage status of the service and preventing data leakage.

In addition, it is possible to determine the properties of a service executed in a user terminal based on packet analysis, such as the identity, event type and usage status of a service executed within the user terminal, and provide a various types of guidance information (e.g., payment method recommendation guidance and product recommendation guidance {advertising}, service or function recommendation guidance, etc.) based on the determined properties of the service, allowing users to use various services more efficiently and conveniently.

The effects of the present invention are not limited to the effects mentioned above, and other effects that are not mentioned will be clearly understood by those skilled in the art from the description below.

The steps of the method or algorithm described in connection with the embodiment of the present invention may be implemented directly in hardware, in a software module executed by hardware, or by a combination thereof. The software module may reside in a random access memory (RAM), read-only memory (ROM), erasable programmable ROM (EPROM), electrically erasable programmable ROM (EEPROM), flash memory, hard disk, removable disk, CD-ROM, or any form of computer-readable recording medium well known in the art to which the present invention pertains.

The components of the present invention may be embodied as a program (or an application) and stored in a medium for execution in combination with a computer as hardware. The components of the present invention may be implemented as software programming or software elements, and similarly, may be implemented in a programming or scripting language such as C, C++, Java, an assembler, or the like including various algorithms implemented in combinations of data structures, processes, routines, or other programming constructs. The functional aspects may be implemented by an algorithm executed in one or more processors.

Although embodiments of the present invention have been described above with reference to the accompanying drawings, a person skilled in the art to which the present invention pertains will understand that the present invention may be implemented in other specific forms without changing the technical spirit or essential features thereof. Therefore, it should be understood that the embodiments described above are exemplary in all respects and not restrictive.

What is claimed is:

1. A method of determining properties of a service executed in a user terminal based on packet analysis, which is performed by the user terminal, the method comprising:
identifying an analysis target packet among packets generated as a service is executed through the user terminal; and
determining properties of the service by analyzing the identified analysis target packet.

2. The method of claim 1, wherein the identifying of the analysis target packet includes selecting, as the service is executed through a virtual private network (VPN) module provided in the user terminal, at least one packet among the plurality of packets provided from the user terminal to a service providing server providing the service as the analysis target packet.

3. The method of claim 1, wherein the identifying of the analysis target packet includes deselecting, as the analysis target packet, a packet whose destination address is a private IP address or a local host address among the plurality of packets generated as the service is executed through the user terminal.

4. The method of claim 1, wherein the determining of the properties of the service includes:
extracting domain information from the identified analysis target packet; and
determining a identity, event type and usage status of the service as the properties of the service using the extracted domain information.

5. The method of claim 4, wherein the extracting of the domain information includes acquiring uniform resource locator (URL) information from the identified analysis target packet through a local proxy module provided in the user terminal or a remote VPN server provided outside the user terminal, and extracting domain information corresponding to the service by parsing the acquired URL information.

6. The method of claim 4, wherein the determining of the identity, event type and usage status of the service includes determining the identity of service corresponding to the extracted domain information by matching pre-stored domain information for each service with the extracted domain information.

7. The method of claim 4, wherein the determining of the identity, event type and usage status of the service includes:
matching pre-stored domain information for each service with a plurality of pieces of domain information extracted from the plurality of packets generated as the service is executed through the user terminal and storing a result of the matching; and
determining the usage status of the service by analyzing the plurality of pieces of domain information, which are matched with the pre-stored domain information for each service and stored, based on a preset usage status determination criterion, the preset determination criterion being based on the identity, event type of service and a current usage status of the service.

8. The method of claim 4, wherein the extracted domain information includes domain name information, information on the number of domain calls, domain call time information, domain call frequency information, domain type information, and access platform information, and
the determining of the identity, event type and usage status of the service includes:
selecting at least one piece of information among a plurality of pieces of information included in the extracted domain information, the plurality of pieces of information including domain name information, information on the number of domain calls, domain call time information, domain call frequency information, domain type information, and access platform information, based on the identity, event type of service and the usage state that will be determined; and
determining the usage status of the service to be one of a service execution state, a service usage state, and a state in which a specific operation is performed in the service, using the selected at least one piece of information.

9. The method of claim 4, wherein the determining of the identity, event type and usage status of the service includes setting a usage status determination criterion for the service in consideration of at least one of an operating system (OS) of the user terminal and an access method of the service, and determining the usage status of the service by analyzing the extracted domain information according to the set usage status determination criterion.

10. The method of claim 4, wherein the determining of the identity, event type and usage status of the service includes extracting a domain information pattern as result data obtained by analyzing the extracted domain information through an artificial intelligence (AI) model previously trained according to a machine learning-based learning method, and determining the usage status of the service based on the extracted domain information pattern.

11. A user terminal that performs a method of determining properties of a service executed in a user terminal based on packet analysis, the user terminal comprising:
a virtual private network (VPN) module configured to identify an analysis target packet among packets generated as a service is executed;
a local proxy module configured to extract domain information from the identified analysis target packet; and
a service property determination module configured to determine the properties of the service by analyzing the identified analysis target packet.

12. A recording medium readable by a computing device on which a program for performing a method of determining properties of a service executed in a user terminal based on packet analysis, the method including:
identifying an analysis target packet among packets generated as a service is executed through the user terminal; and
determining properties of the service by analyzing the identified analysis target packet.
